(19) United States
(12) Patent Application Publication
(10) Pub. No.: US 2026/0206692 A1
(43) Pub. Date: Jul. 23, 2026

(54) GARDEN SYSTEM

(71) Applicant: OmniGro, Snohomish, WA (US)

(72) Inventors: Larry Wilson, Forest Ranch, CA (US); Corine Wilson, Forest Ranch, CA (US); Andrea Wilson, Kalaheo, HI (US); Jesus J. Pena, Yorba Linda, CA (US)

(73) Assignee: OmniGro, Snohomish, WA (US)

(21) Appl. No.: 19/455,180

(22) Filed: Jan. 21, 2026

Related U.S. Application Data
(60) Provisional application No. 63/747,512, filed on Jan. 21, 2025.

(51) Int. Cl. A01G 9/02; A01G 25/16

(52) U.S. Cl. CPC A01G 9/0302; A01G 25/165

(57) ABSTRACT

The garden system described herein is a versatile and scalable solution for growing plants in a controlled environment. The system includes of sets of containers adaptable to various growing methods, such as soil-based, deep water culture, NFT (Nutrient Film Technique), ebb and flow, drip, and vertical growing tubes. The system is expandable by connecting hoses, operates above ground in a closed environment, and is both ecologically and environmentally responsible. It features a water recirculating system and utilizes advanced technology to optimize overall functionality. The system can be configured with multiple lower bins as water reservoirs, and it dispenses water through an internal water manifold with protruding barbed irrigation fittings. Additionally, the system includes provisions for attaching a trellis or grow rack to the upper bins.

### CLAIM OF PRIORITY

This application claims priority to Provisional Patent Application Ser. No. 63/747,512 filed on Jan. 21, 2025, the entirety of which is hereby incorporated by reference.

### TECHNICAL FIELD OF THE DISCLOSURE

The present disclosure relates to a garden system for growing plants.

### BACKGROUND OF THE DISCLOSURE

Existing garden systems require extensive infrastructure to develop and maintain. Moreover, many of the existing agricultural and garden systems are not integrated but are separate systems that must be logistically combined or operated, which can be costly and time consuming.

The present disclosure relates to a unique and innovative garden system including an upper and lower container (referred to as a “set”) operated by a control box containing a pump and a timer (optional computer). The system is expandable by adding additional sets, connected by hoses, that provide water to the plants and drain excess water back to a central water reservoir. The modular system allows for real food production in environments such as parking lots or rooftops without the need for extensive infrastructure.

Thus, there is a need for a new and improved garden system that overcomes deficiencies in existing systems while providing better overall results.

### SUMMARY OF THE DISCLOSURE

In accordance with an embodiment of this disclosure, a modular, closed, above-ground garden system, has a control box containing a pump, timer and a water filter; a plurality of upper and lower bins, wherein the upper bin provides for passive draining and recycling of water into the lower bin; wherein the lower bin functions as a water reservoir; an internal water manifold within the upper bin; and recirculating water channels to reuse water to reduce overall water usage; wherein said system has a modular configuration to multiple systems to be connected together.

In accordance with another embodiment of the disclosure, a modular, closed above-ground garden system, has a control box having a pump, a water filter, and a timer; a lower reservoir for holding water; and manifold positioned relative to the associated plants to be watered.

In accordance with another embodiment of the disclosure, a modular, closed garden system, has an upper bin to provide water to roots of associated plants; a timer to control water flow to the upper bin; a lower bin which provides a water reservoir; a pump, and water filter which pumps water from the lower bin to the upper bin; wherein the pump pumps water to the upper bin faster than the upper bin drains, wherein the excess water leaves the upper bin and reaches the roots of associated plants.

In accordance with one aspect of the disclosure, a garden system has upper and lower containers or bins separated by a control box having a pump and a timer.

In accordance with another aspect of the disclosure, multiple above-ground agricultural technologies are combined into a single, innovative system. This system integrates the following features: irrigation lines, raised beds, passive water recycling, vertical growing, hydroponic, aeroponic, and soil-based growing methods.

The lower bin of the disclosure includes a water reservoir and stand. The lower bin functions as a water reservoir, collecting and storing water separately from the growing substrate, while also acting as a stand for the top bin. The lower bin also includes an additive port which features a sealed port with a cap for easy addition of nutrients to the water reservoir. The port is designed to prevent evaporation and block external contaminants, such as pathogens or debris from entering the system. The lower bin can include a mobility and leveling feature that has detachable wheels and self-leveling devices, ensuring precision leveling of the unit.

The upper bin of the disclosure includes a feature for passive drainage and recycling that is engineered with specific angles to allow unused water to drain passively into the lower bin for recycling. The upper bin also includes an irrigation manifold that contains a specialized manifold designed to sustain consistent water pressure and distribute water evenly. The upper bin can include a vertical trellis integration that includes engineered attachment points on the top lip for quick and easy vertical trellis installation. The upper bin also preferably includes a soil separator which features a built-in separator to prevent growing substrate from entering the water reservoir.

According to another aspect of the disclosure, the system integration includes quick connect ports. Both upper and lower bins are equipped with quick-connect ports, allowing multiple bins to link into a single, closed-loop system or to be capped at the end of a row.

The system preferably includes a pump housing, which is a specially designed housing that attaches to any bin to convert it into the lead bin. This housing accommodates the pump, timer, and filter required to operate an entire row of connected bins. It is engineered to prevent overheating, adapt to various pump sizes, minimize vibration to prevent damage and protect and enclose critical components.

Both upper and lower bins are specifically engineered to withstand full weight loads of soil, water, and plants across various growing mediums. They are also designed for efficient shipping and storage, with the ability to stack and nest compactly.

The highly versatile and modular system is a cutting-edge solution for diverse agricultural applications, providing a seamless integration of multiple growing methods and technologies into a unified platform.

According to another aspect of the disclosure, the system is an above-ground, closed ecosystem garden system having engineered containers that conserve water and utilize removeable growing mechanisms.

According to another aspect of the disclosure, the system recirculates and filters water, reducing overall usage and preventing groundwater pollution.

According to another aspect of the disclosure, the system operates using a control box containing a pump, water filter, and timer, with optional components like an aerator and computer for enhanced control.

In accordance with another aspect of the disclosure, the system is adaptable to various growing methods, including Soil, NFT (Nutrient Film Technology), Aeroponic, Deep Water Culture, Ebb and Flow, and Drip. It is designed for scalability, allowing it to be used in a single unit or in large commercial operations.

In accordance with still another aspect of the disclosure, the system has a lower bin which functions as a water reservoir, and an upper bin which serves as the growing container. These sets can be used individually or connected in series. The pump supplies water to the upper bin through a water manifold, which distributes water to the plants via irrigation tubing. Excess water is drained back to the lower bin and recirculated.

In accordance with another aspect of the disclosure, the system is constructed from food-grade UV-resistant HDPE, providing durability and strength.

In accordance with yet another aspect of the disclosure, the system is expandable by means of connecting hoses; is an above ground closed environment; is scaleable (can be used as a single unit or large commercial operations), and is ecologically and is environmentally responsible (no ground water pollution and limits water usage).

In accordance with another aspect of the disclosure, the system uses a water recirculating system; can utilize one or more lower bins as water reservoirs as needed by using connecting hoses; and dispenses water through an internal water manifold and protruding barbed irrigation fittings.

In accordance with another aspect of the disclosure, the system has protrusions on the ends of the upper bins to attach a trellis or grow rack.

In accordance with another aspect of the disclosure, the system supports multiple growing methods:
Soil Method: Soil is placed in the upper bin, which functions as a traditional garden.
Aeroponic Method: Nutrient-rich water is sprayed onto plant roots suspended in net pots within the upper bin.
NFT Method: Water flows through growing channels, providing nutrients to plants in a nutrient film technique.
Ebb and Flow Method: Water fills the upper bin to reach the roots of the plants, then drains back to the lower bin in cycles.
Deep Water Culture: plants are grown in nutrient-rich water with oxygen supplied by air stones.
Drip Method: Water is delivered to plants via drip lines or sprinklers.
Suspended Grow Tubes: Vertical tubes with plants are irrigated from the top down, providing a space-efficient growing method.

Still other aspects of the disclosure will become apparent upon a reading and understanding of the following detailed description.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 is a perspective view of an upper bin in accordance with a preferred embodiment of the disclosure;

FIG. 2A is a perspective view of a lower bin in accordance with a preferred embodiment of the disclosure;

FIG. 2B is a top plan view of the lower bin;

FIG. 2C is a front elevational view of the lower bin;

FIG. 3 is a perspective view of the upper and lower bins and the pump housing;

FIG. 4 is a front elevational view of the upper and lower bins and the pump housing;

FIG. 5 is an exploded perspective view of the upper bin, the lower bin and a seal;

FIG. 5A is an exploded perspective view of a manifold used with the upper bin;

FIG. 6 is a schematic view of a garden system using Grow Tubes, according to an embodiment of the present disclosure;

FIG. 7 is a schematic view of a garden system using a “drip method” configuration;

FIG. 8 is a schematic view of the garden system using an “aeroponic method” configuration;

FIG. 9 is a schematic side view of the garden system using a “nutrient film method” configuration;

FIG. 10 is a schematic end view of the garden system of FIG. 9;

FIG. 11 is a schematic view of a garden system using an “ebb and flow method” configuration;

FIG. 12 is a schematic view of a garden system using a “deep water culture” configuration;

FIG. 13 is a schematic view of a garden system using a “soil method” configuration;

FIG. 14 is a schematic view of a “leveling platform” for the garden system;

FIG. 15 is a schematic view of a “vertical growing tower” for the garden system;

FIG. 16 is a schematic view of a “soil screen/separator” for the garden system;

FIG. 17 illustrates another embodiment of the soil screen/separation;

FIG. 18A is a perspective view of another soil separator;

FIG. 18B is a top plan view of the separator;

FIG. 18C is a side elevational view of the separator;

FIG. 19A is a perspective view of a seal or mosquito barrier;

FIG. 19B is a top plan view of the seal;

FIG. 20A is a perspective view of a pump housing;

FIG. 20B is a top plan view of the pump housing;

FIG. 20C is a perspective view of a lid for the pump housing;

FIG. 21 is a schematic view of different lids designed to fit on the edges of the upper grow bin for the garden system;

FIG. 22 illustrates an alternate lid configuration;

FIG. 23 illustrates a combination trellis/tower and rack;

FIG. 24 is a perspective view of another trellis and bin configuration;

FIG. 25 is a perspective view of another trellis and bin configuration;

FIG. 26 is a perspective view of another trellis and bin configuration; and

FIG. 27 is a perspective view of another trellis and bin configuration.

### DETAILED DESCRIPTION OF THE PREFERRED EMBODIMENTS

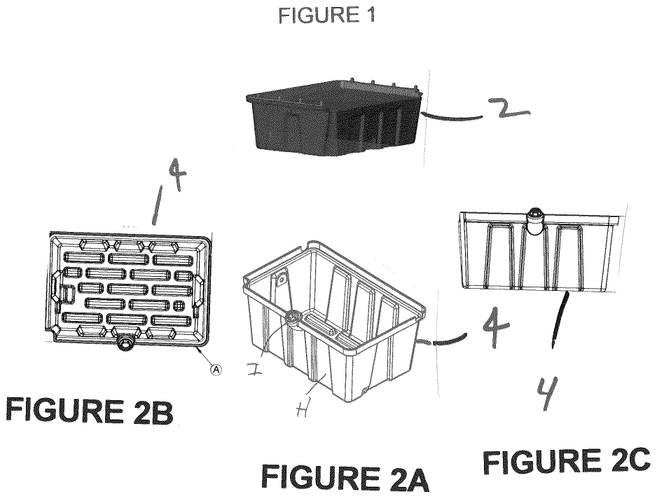

Referring to FIGS. 1 and 2A, 2B and 2C, the disclosure relates to an above ground closed ecosystem garden which includes upper bins 2 and lower bins 4.

The upper bin 2 includes a feature for passive drainage and recycling that is engineered with specific angles to allow unused water to drain passively into the lower bin for recycling. The upper bin also includes irrigation manifold that contains a specialized manifold designed to sustain consistent water pressure and distribute water evenly. The upper bin features a vertical trellis integration that includes engineered attachment points on the top lip for quick and easy vertical trellis installation. The upper bin also includes a soil separator which features a built-in separator to prevent growing substrate from entering the water reservoir.

The lower bin 4 includes a water reservoir and stand. The lower bin functions as a water reservoir, collecting and storing water separately from the growing substrate, while also acting as a stand for the top bin. The lower bin also includes an additive port which features a sealed port with a cap for easy addition of nutrients to the water reservoir. The port is designed to prevent evaporation and block external contaminants, such as pathogens or debris. The lower bin includes a mobility and leveling feature that includes detachable wheels and self-leveling devices, ensuring precision leveling of the unit.

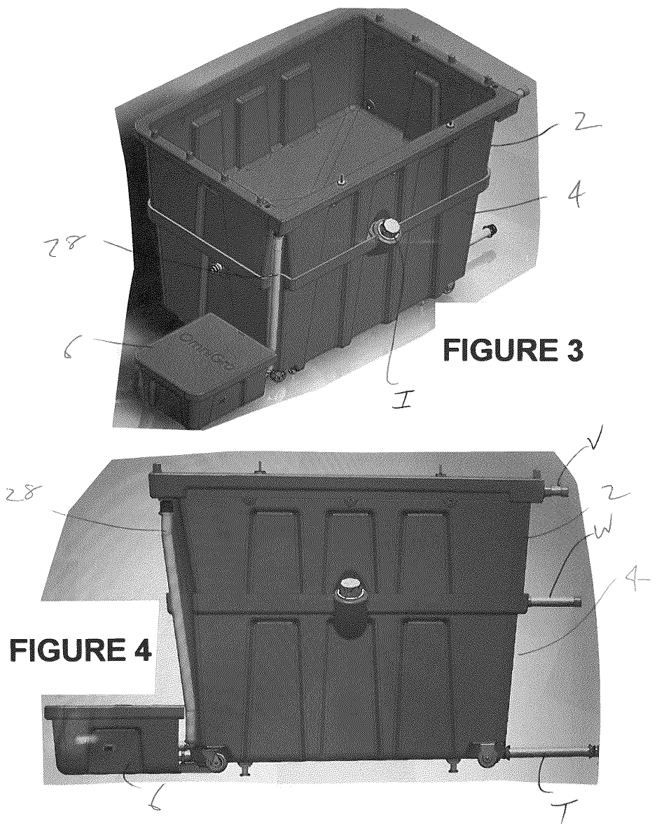

FIGS. 3 and 4 illustrate the assembled upper and lower bins 2, 4 and a pump housing 6.

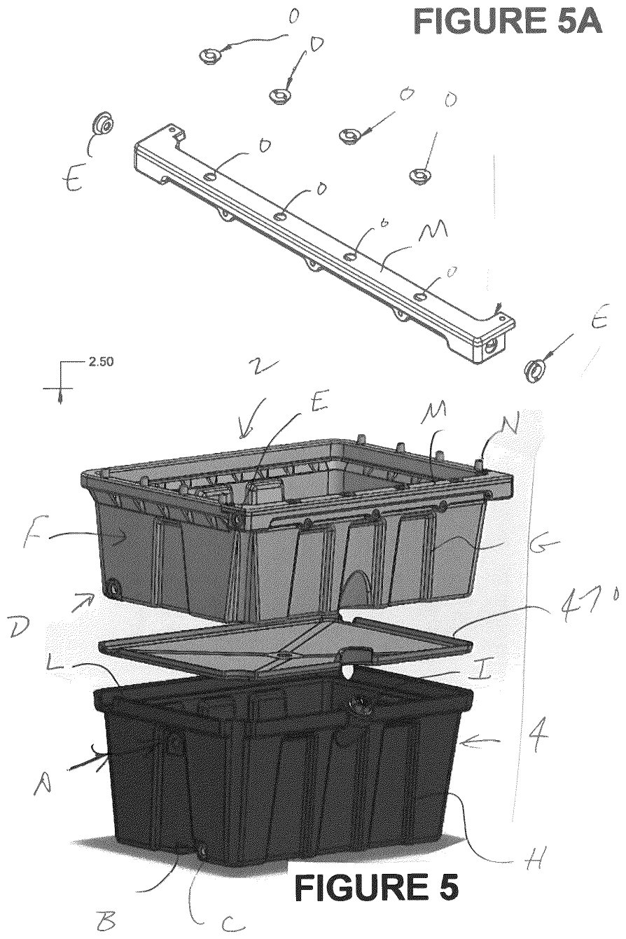

Referring now to FIG. 5, various components of bins 2 and 4 are shown. A float valve serves as a shut off for the water entering the reservoir externally. It also allows water to fill the reservoir as needed so no monitoring is required for additional water.

A quick disconnect B is engineered into the lower bin 4 to connect/disconnect the pumphouse 6 (see FIGS. 3, 4, 20A and 20B).

A plug C is engineered into a drain hole in the lower bin 4 to connect or plug the water reservoirs. The drain hole allows/stops pressure water flow to return to the reservoir for recirculation via tubing T (FIG. 4).

A flow opening D is engineered into the upper bin 2 to allow passive water to flow between the bins via tubing W (FIG. 4) and back to the water reservoir for collection.

Connection E is used to connect or plug the water to irrigation manifolds M (FIG. 5A) between upper bins 2 via tubing V (FIG. 4).

Watering manifold M has been engineered to sustain water pressure needed to efficiently get water to multiple bins and the plants in the bin and/or on the trellis. The manifold has four openings O which allow for a variety of operations for a grower to place small irrigation lines and emitters for irrigation. The four ports O connect multiple methods of watering to the manifold easily and quickly. There are connecting hoses between the manifold M and the bottom of upper bin 2. The hoses allow the entire manifold to pressurize and spray the plants at the same time. A return drain allows the water to passively return to the reservoir of lower bin 4.

A vertical channel F is provided on upper bins 2 to allow for external plumbing to directly reach the manifold without protruding and potentially being disconnected.

Channels G, H are provided in all of the upper and lower bins are engineered for structural integrity to withstand the weight loads on the structures.

Lip L on the lower bin 4 fits snugly to the upper bin 2 to ensure no outside pests or pathogens get into the system, it also acts as a barrier for crawling pests to not be able to enter the plant or growing medium. The lip has been engineered to support weight from the trellis, and to act as a deterrent for climbing pests.

Additive ports I have been engineered into every lower bin 4 to open and close the water reservoir.

A slope is formed on the bottom bin and water flow to the bottom of the collection of the upper bin collection for recirculation.

A knob N has been engineered to quickly connect a vertical trellis system to the upper bin 2.

All upper bins 2 are connected for passive water recirculation.

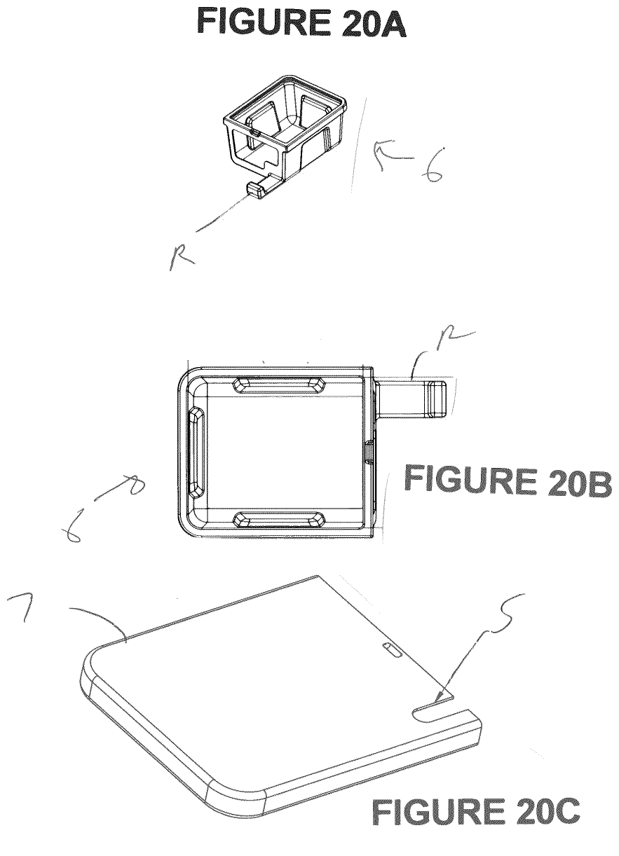

A connector R (FIGS. 20A, 20B) easily connects the pump house 6 to the lower bin 4 to create stability.

Holes have been engineered to allow entry and exit of water tubing in the system and to act as ventilation for the heat of the pump.

Pump housing 6 has been engineered to allow entry and exit of water tubing, to house and hold the pump, to allow heat to escape from the pump housing, and to hold and protect the pump, timer, and the filter. Referring to FIG. 20C, the pump housing 6 has a lid 7 which has a slot S for receiving a pressure hose.

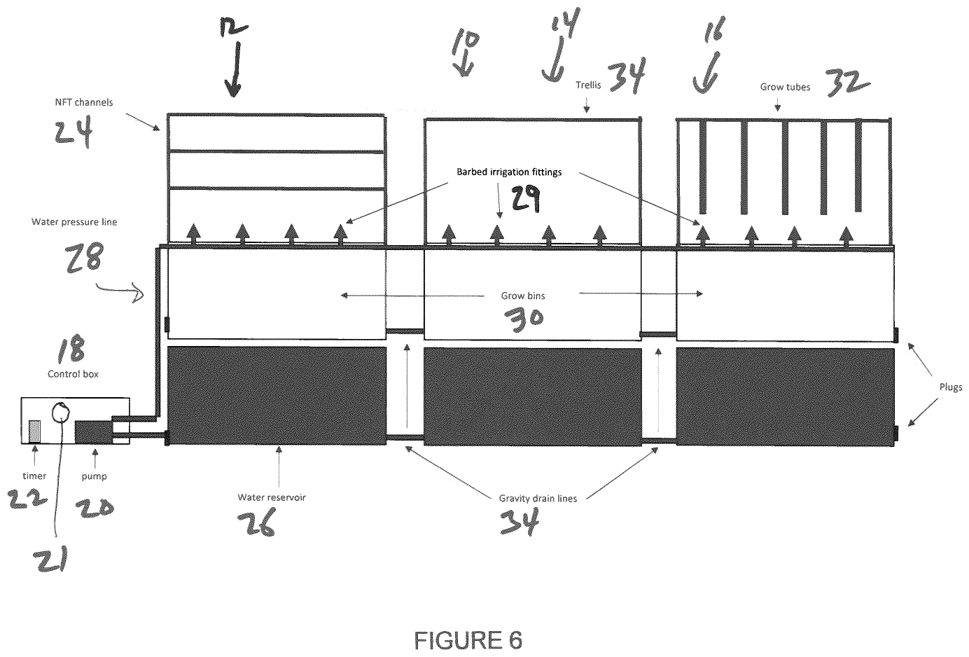

Referring now to FIG. 6, the disclosure relates to an above ground closed ecosystem garden 10 including sets of engineered containers or bins 12, 14, 16 that can be used in a variety of ways. It is designed to conserve water and use natural and renewable growing mediums by capturing excess water, filtering it and using the enriched water again. Each time the water percolates through the rich growing medium (enriched organic renewable compost) the water becomes more nutrient dense. The system operates with a control box 18 containing a pump 20, water filter 21 and a timer 22 (optional equipment may include an aerator and/or computer). The system can operate on regular 110V house current or solar/wind power. Water can be drawn from the air using an atmospheric water generator. The system can accommodate a computer monitoring system that controls water and plant vigor. The system has been designed to operate various growing modalities including, but not limited to, soil, NFT (Nutrient Film Technology), Aeroponic applications, Deep Water Culture, Ebb and Flow and Drip). The system uses recirculating water channels 24 to reuse water reducing water usage and eliminating any ground water pollution.

The water is drawn from lower bins or reservoirs 26 and is pumped through water pressure lines 28 to the water manifolds and barbed irrigation fittings 29 of upper or grow bins 30. The water is then fed through the ¼-½ inch tubing 32 to the plants. The unused water drains back to the water reservoir via gravity drain lines 34. The water is then filtered and reused. The only water loss is through the plants respiration.

When using multiple grow bins 30 the water use increases. When this occurs more than one water reservoir 26 can be used by connecting water reservoirs together by hoses. The system can utilize several kinds of growing methods, some of which use a trellis 34, while others would use grow tubes 32. Suspended grow tubes 32 can be used to grow vertically. This method utilizes tubes with holes in them in which plants are placed. These tubes are suspended from a tower rack and water is pumped up to the top of each tube and flows down through the tube feeding the plants. The tubes are filled with a growing medium that holds moisture allowing the plants time to absorb nutrients.

The system 10 can operate on regular 110V house current or solar/wind power. Water can be drawn from the air with an atmospheric water generator. The system can accommodate a computer monitoring system that controls water and plant vigor. The system uses recirculating water channels 24 such as NFT channels and reuses water reducing water usage and eliminates any ground water pollution.

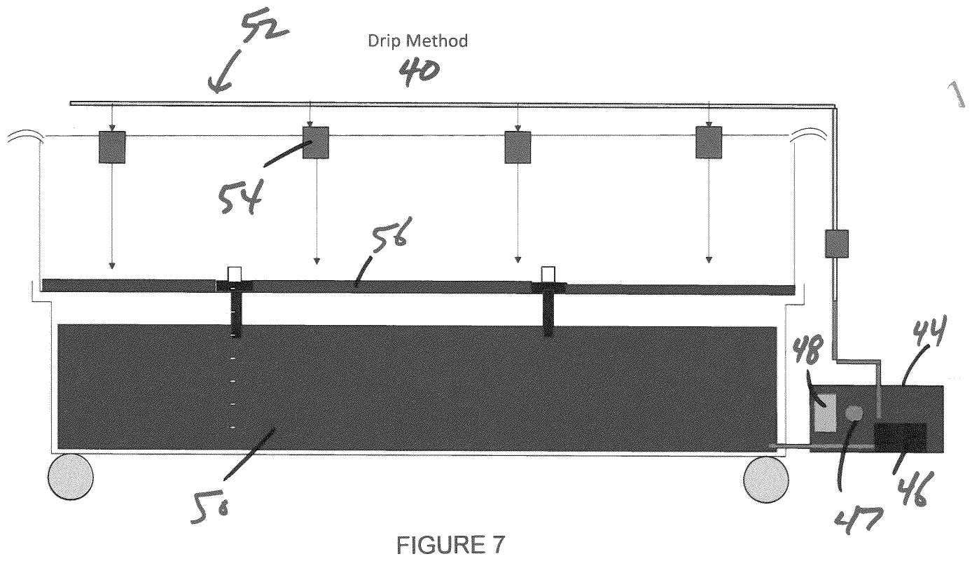

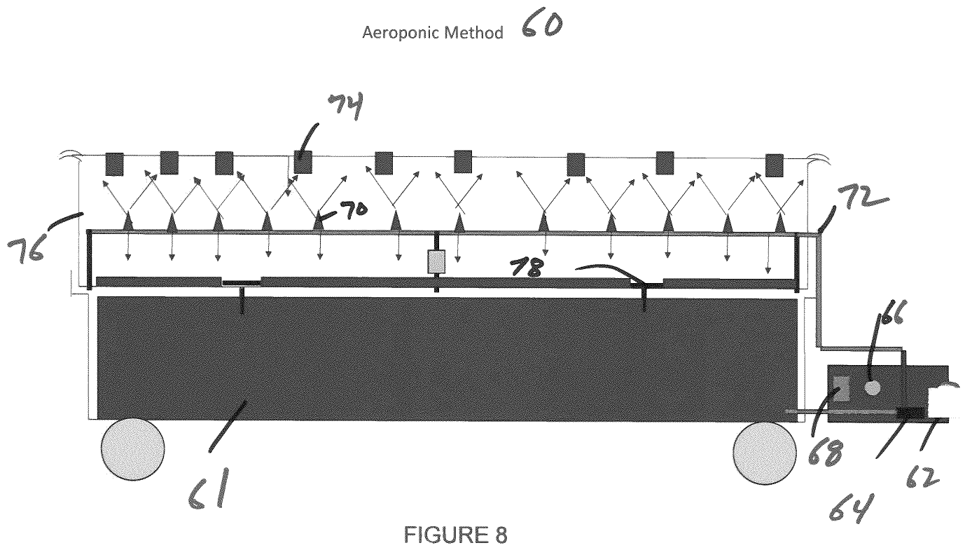

Referring to FIG. 7, a Drip Method 40 can be utilized in the soil method or be combined with sprinklers. A control box 44 having a pump 46, a water filter 47 and timer 48 is used to pump the water from a water reservoir 50 to the overhead manifold 52 and then the water is dispersed or drips onto plants 54 via the drip hoses or sprinklers. Excess water is drained via lines 56 back into the water reservoir 50.

Referring now to FIG. 8, an Aeroponic Method 60 is shown. In this system, nutrient rich water is sprinkled onto plant roots suspended in net pots within the upper bin.

Specifically, the water is applied from a water reservoir 61 (i.e. lower bin) using a control box 62 having a pump 64, a water filter 66 and timer 68. The water is pumped up to and sprayed via nozzles 70 spaced apart on a manifold 72. The water is sprayed upwardly to roots of plants in net pots 74 suspended above the spray nozzles in upper bin 76. Excess and residual water drips down via drain channels or lines 78 into reservoir 61.

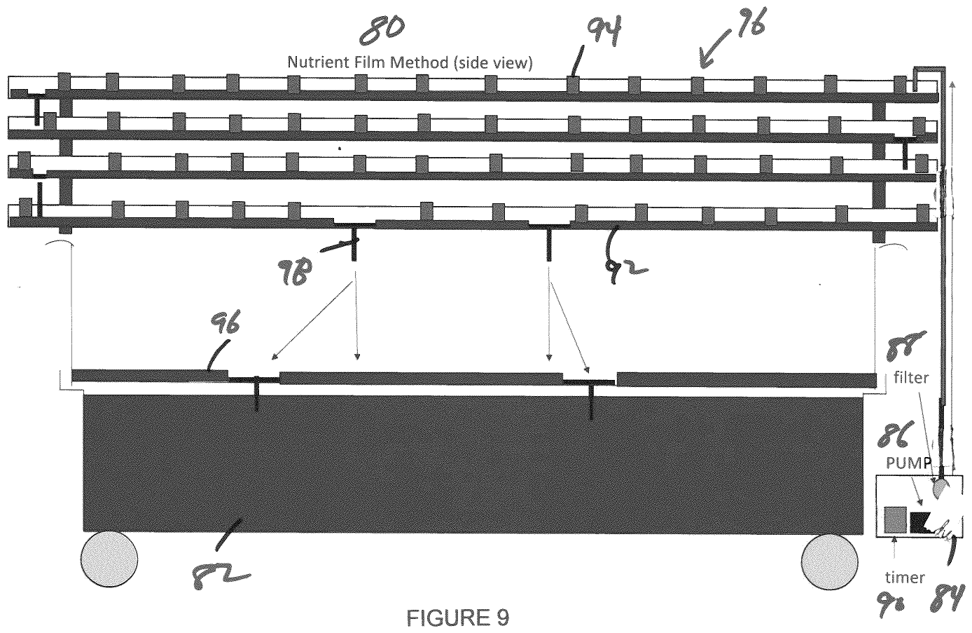

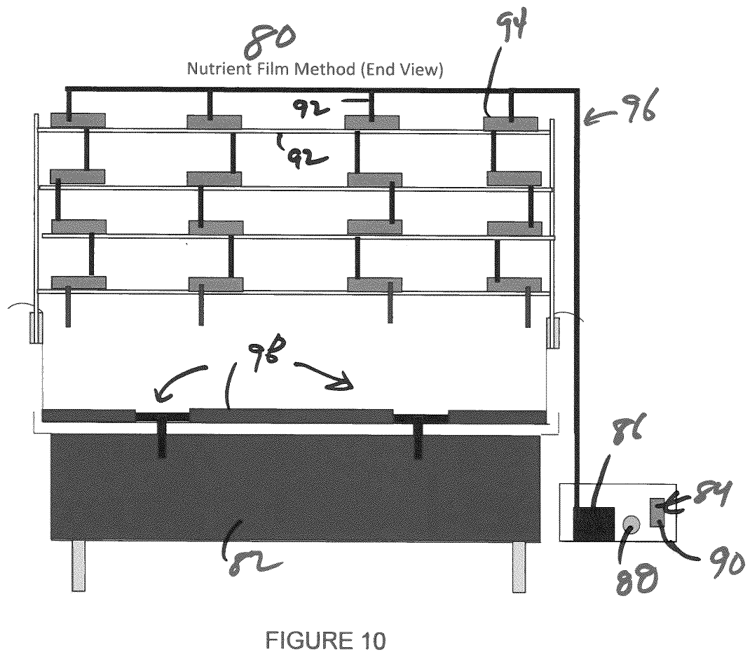

Referring to FIGS. 9 and 10, a Nutrient Film Technology Method (NFT) 80 is shown. In this method, water flows through growing channels providing nutrients to plants. Water is supplied from a water reservoir 82 (i.e. lower bin) using a control box 84, having a pump 86, a water filter 88 and a timer 90. The water is pumped through nutrient film channels 92 providing nutrients to plants in net pots 94 located in upper bin 96. Excess water drips via drain channels 98 back into water reservoir 82.

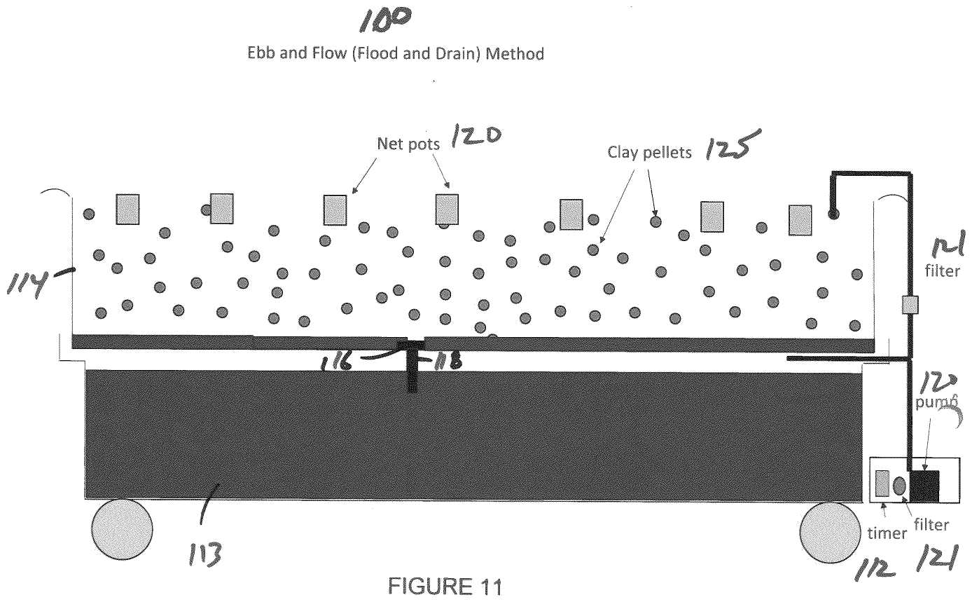

Referring to FIG. 11, an Ebb and Flow Method 100 is shown. Water fills the upper bin 114 to reach the roots of the plants, then drains back to the lower bin in cycles. The Ebb and Flow method 100 uses a timer 112 to control the flow of water into the upper bin 114. The water is pumped from reservoir 113 using pump 120, a water filter 121 and timer 112. The upper bin requires a reducer bushing 116 to be placed in the drain hole 118 of the lower portion 110 of upper bin. The pump 120 fills up the upper bin faster than the water drains out. This means that the upper bin will slowly fill up until the water reaches the roots of the plants suspended in net pots 120 held in holes in a lid. Clay pellets 125 are placed in the upper bin 114 and become soaked by the water and disperse nutrients into the water. The timer 112 will turn off and the water will gradually subside, draining back into the lower bin. The timer will run for a specified time (enough to fill the upper bin) and then turn off and remain off for a lengthy period allowing the roots to dry and oxygenate. Then the cycle will be repeated. The cycle time will depend upon the type of vegetable being grown.

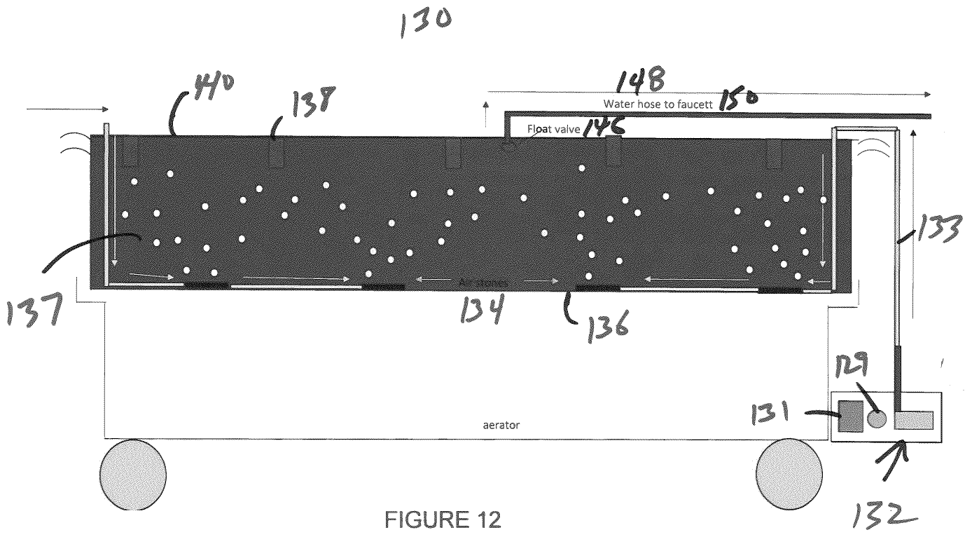

Referring now to FIG. 12, Deep Water Culture 130 is another modality that that can be used with this system. This method uses an air pump 132 (with timer 131 and filter 129) that forces air using an air hose 133 into air stones 134 (diffusers) located in the bottom of the upper bin 137 which is filled with nutrient rich water. The plants again are placed in net pots 138 suspended from the lid 140. The air pump provides oxygen to the plants as they are growing entirely in water.

A float valve 146 is used to connect a water hose 148 to a faucet 150 to add water to the upper bin.

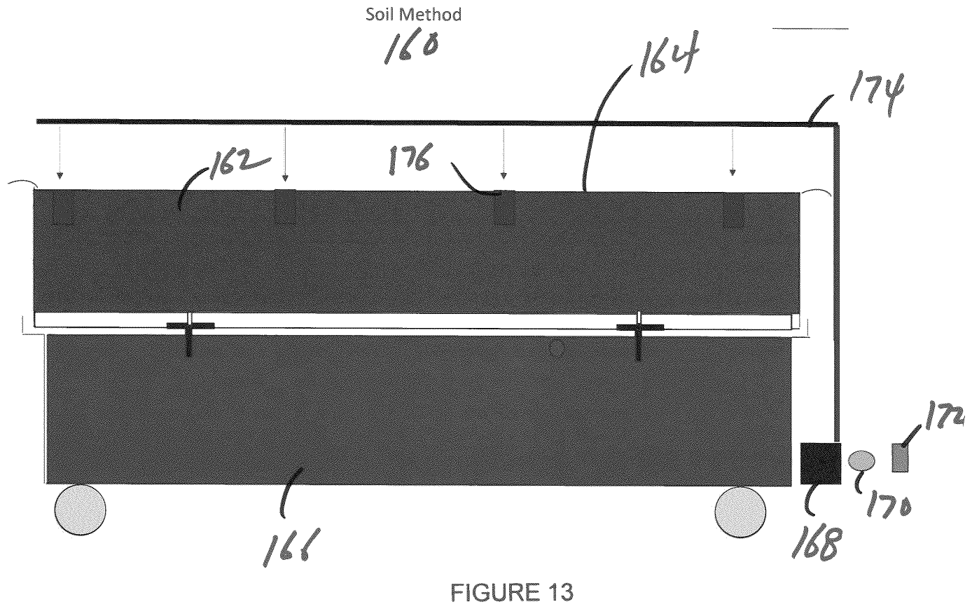

Referring to FIG. 13, a Soil Method 160 is shown, where soil 162 is placed in upper bin 164, which functions as a traditional garden, water is pumped from reservoir 166 (i.e. lower bin) using pump 168, a water filter 170 and a timer 172. Water is dispersed using manifold 174 onto plants 176 located in soil 162 of upper bin 164.

Each of the systems detailed above allow for scalability from one set to hundreds of sets in a commercial application. They can be used on roof tops, balconies, parking lots, greenhouses, parks, etc. Commercial applications require a different operation design. In this application the bottom stand would function only as a stand. A buried water tank (cistern) would be employed along with a commercial pump. A manifold would be connected to a series of pipes that feed various sections of “sets”. Large greenhouses would be able to utilize the system by dividing up the greenhouse into sections, each section operating with a specified cistern and pump.

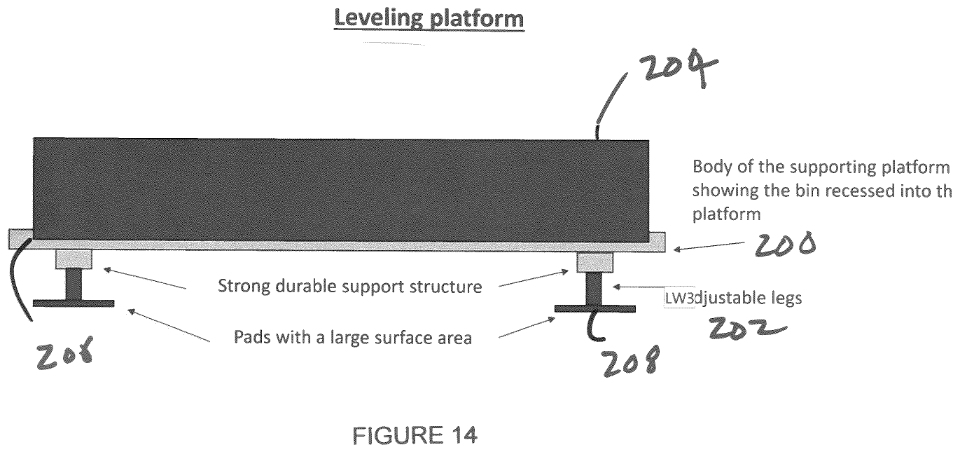

Referring to FIGS. 14-17, various attachments are shown which can be used with the garden system. Referring to FIG. 14, a rectangular leveling platform 200 has adjustable legs 202 located on each of the four corners. The grow bins 204 sit on top of this platform. The adjustable legs allow for the alignment of each individual grow bin 204 to facilitate drainage in the case of even or rough site conditions. The platform has sides 206 or edges to contain the grow bin and keep it from sliding on the platform. In addition, it is designed to accommodate the weight of the upper and lower grow bins and give it structural integrity. The supporting legs can have pads 208 that have a large surface area to support the weight of the bins and not sink into the ground. The location of the legs will be engineered to maximize the strength and function of the platform.

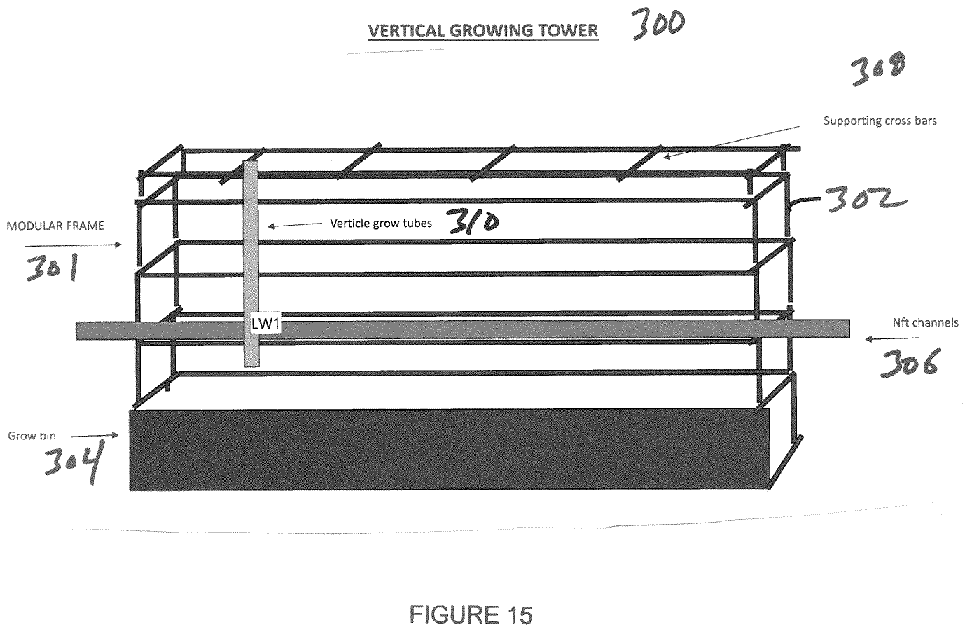

Referring to FIG. 15, a vertical growing tower 300 has a modular frame structure 301 made of hollow tubing 302 constructed to fit onto the growing bins 304. The frame may have three or more layers/levels which holds horizontal NFT (Nutrient Film Channels) 306 which hold and distribute nutrient rich water to plants within the channels. Each channel distributes water to the lower level until the water returns to the water reservoir. The water is pumped from the water reservoir through the hollow tubing that forms the tower, or through drip lines that are inserted into the hollow tubing, or through apertures molded into the sides of the hollow tubing.

Horizontal cross members or bars 308 are added at the top of the tower. The purpose of the horizontal cross bars is to support vertical growing tubes 310. Plants are placed in hollow cups formed into the tubes. Water is then pumped up to the top of the tubes and flows down the interior of the tube carrying nutrient rich water to the plants in the pockets of the tube. The tubes can be filled with various growing mediums such as coco coir; peat moss, etc. The water that drains out of the bottom of the vertical tubes 310 and returns to the water reservoir.

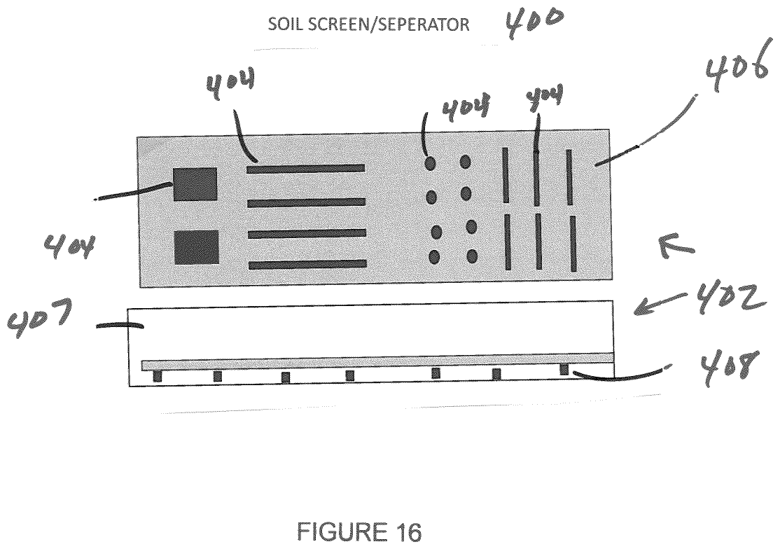

Referring to FIG. 16, a soil screen/separator 400 is shown which is formed by plastic tray 402 with holes/slots 404 covered with a screen or filtering membrane 406 that sits in the bottom of the grow bin 407. It has nubs/protrusions/feet 408 that hold the tray above the bottom of the bin creating space for water drainage. The purpose of this screen is to divide the growing medium/dirt or sediment from encroaching into the water drainage area and the reservoir of the lower bin and yet provide for adequate water drainage. The shape of the drain holes can be varied for optimum effect. Various shapes and configurations can be used.

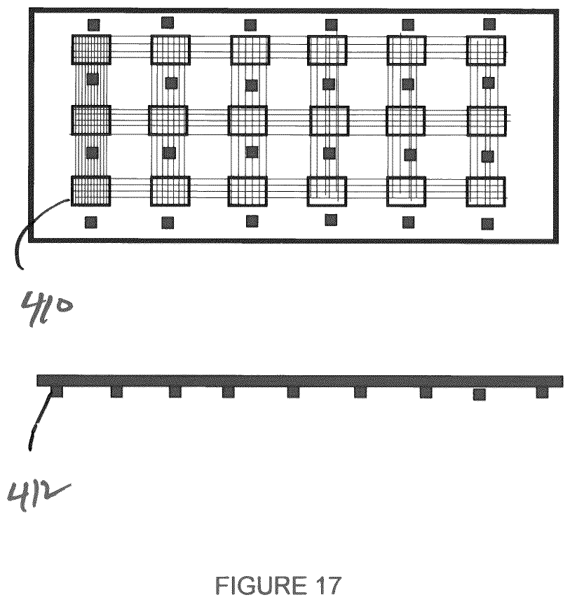

Referring to FIG. 17, separators can be covered by a fine mesh/screen 410. The screen can be one piece covering the whole area or small squares covering each opening. Protrusions 412 are ⅜ or ½ inch and space the screen from the bottom of the separator.

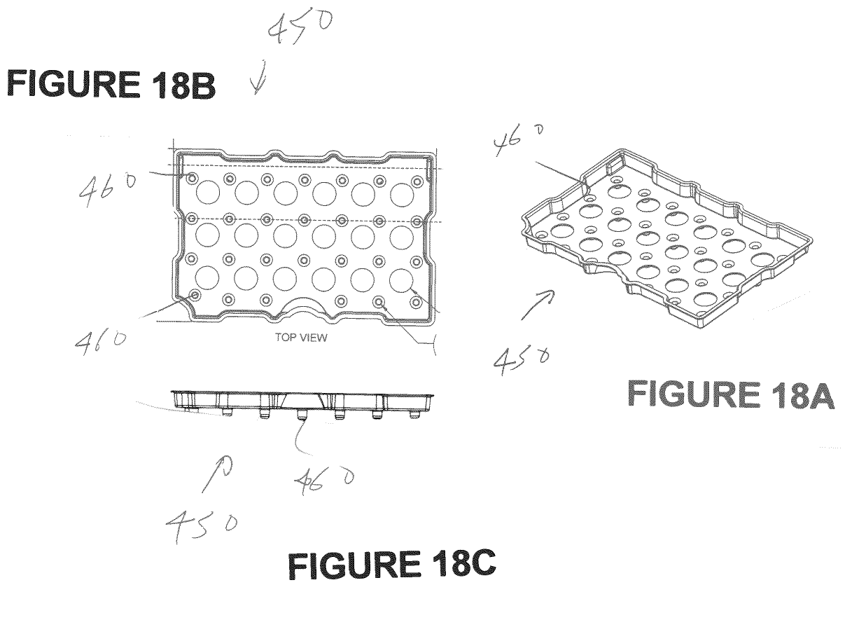

Referring to FIGS. 18A, 18B, 18C another soil separator configuration 450 is shown. The separator 450 is mounted on a bottom surface of the upper bin 2 to prevent sediment/soil from clogging return drains. The separator 450 has a plurality of openings and drain holes 460 which allows for separation of the water from soil.

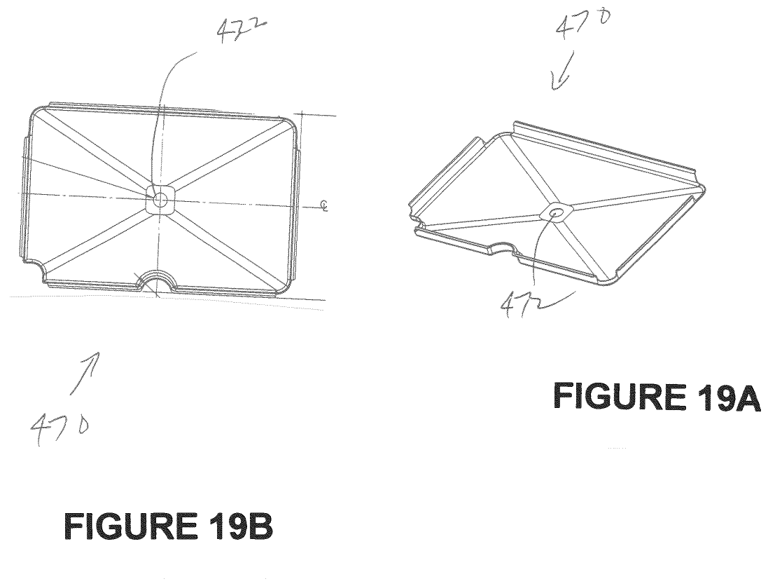

Referring to FIGS. 19A and 19B, a seal or mosquito barrier 470 is shown. The seal is mounted onto the upper end of the lower bin and serves as a barrier to prevent unwanted items from entering the lower bin, such as mosquitoes. FIG. 5 shows a single seal mounted between the upper and lower bin to hole or opening 472 allows water to pass into the lower bin.

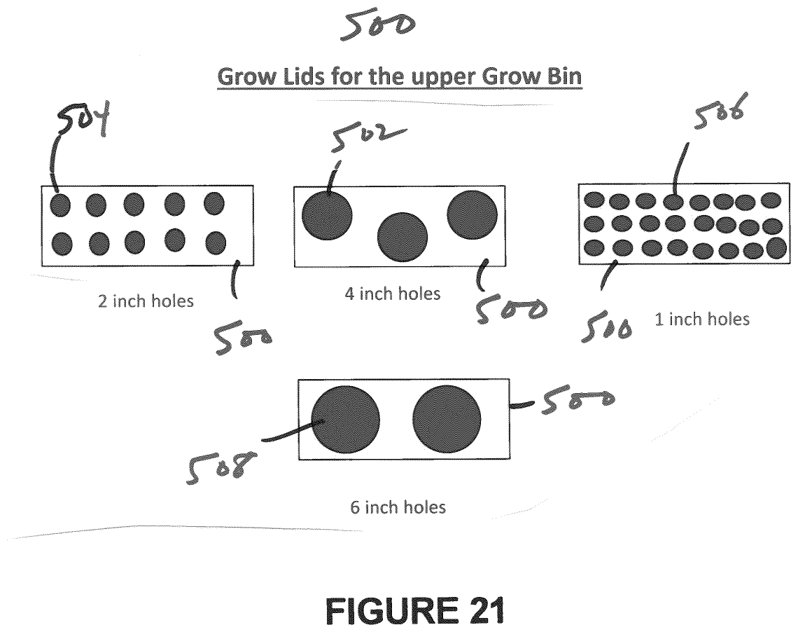

Referring to FIG. 21, grow lids 500 from an upper grow bin are shown. The lids are designed to fit and lock into place on the upper edges of the upper grow bin. They are configured to hold the weight of the plant and produce. The lids will be created with various size holes 502, 504, 506, 508 to accommodate the many different sizes of net pots. There is no limitation of the size, layout, or orientation of the holes. Holes 502 are 4 inches, holes 504 are 2 inches, holes 506 are 1 inch while holes 508 are 6 inches.

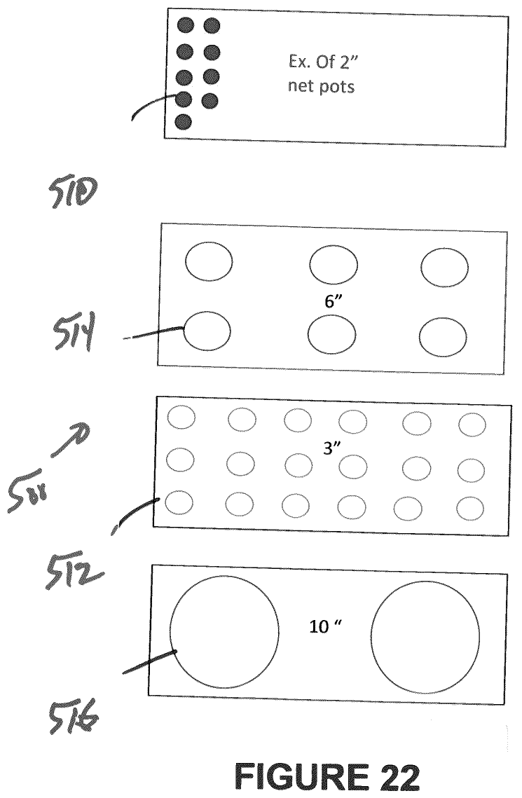

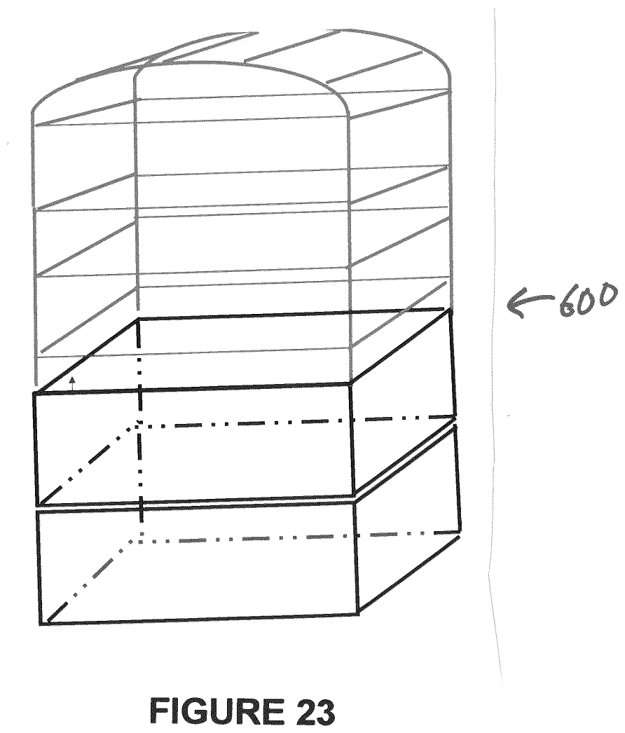

Referring to FIG. 22, lids 500 can have holes equally centered and spaced. Various sizes, such as 2 inches 510, 3 inches 512, 6 inches 514 and 10 inches 516 are shown. The lids need to be strong enough to hold the weight of the plants and fruits/vegetables.

Referring to FIG. 23, a combination tower/trellis and rack 600 is shown.

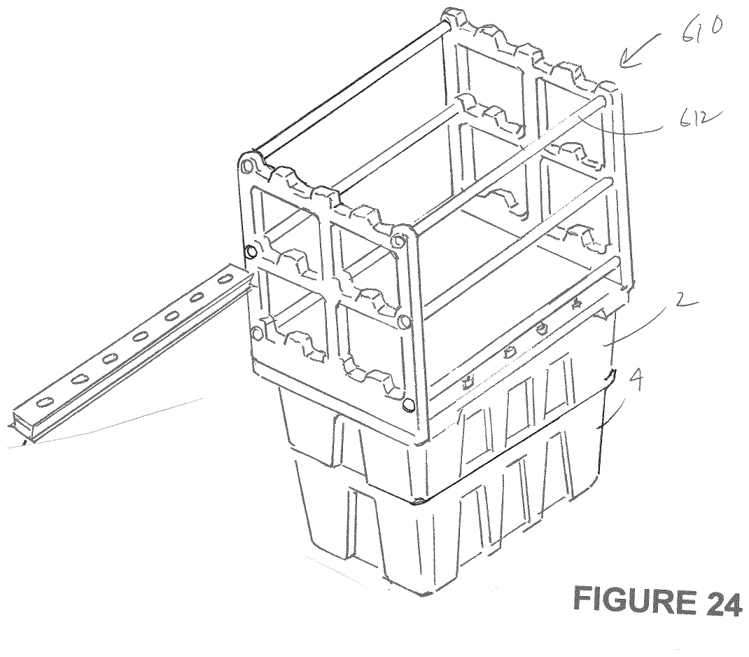

FIG. 24 shows another trellis 610 and connectors 612 and upper and lower bins 2, 4 configuration.

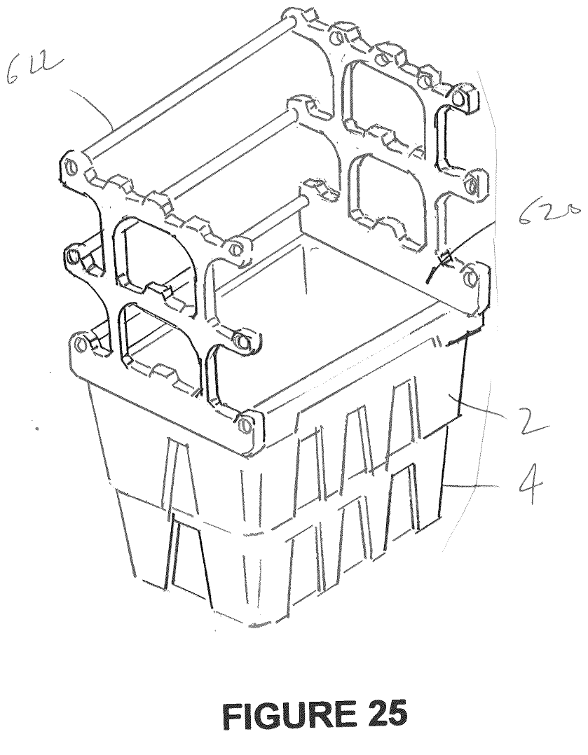

FIG. 25 shows another trellis 620 and connectors 622 and upper and lower bins 2, 4.

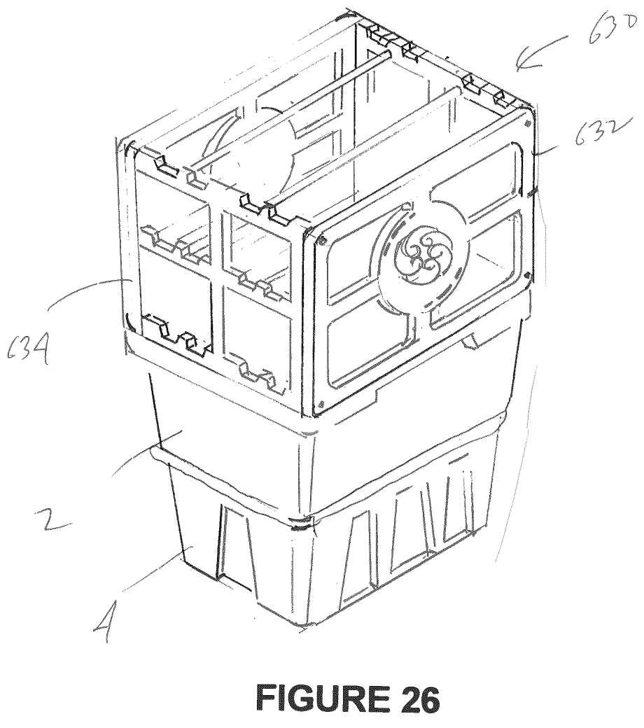

FIG. 26 shows another trellis 630 with side panels 632 and panels 634 and upper and lower bins 2, 4.

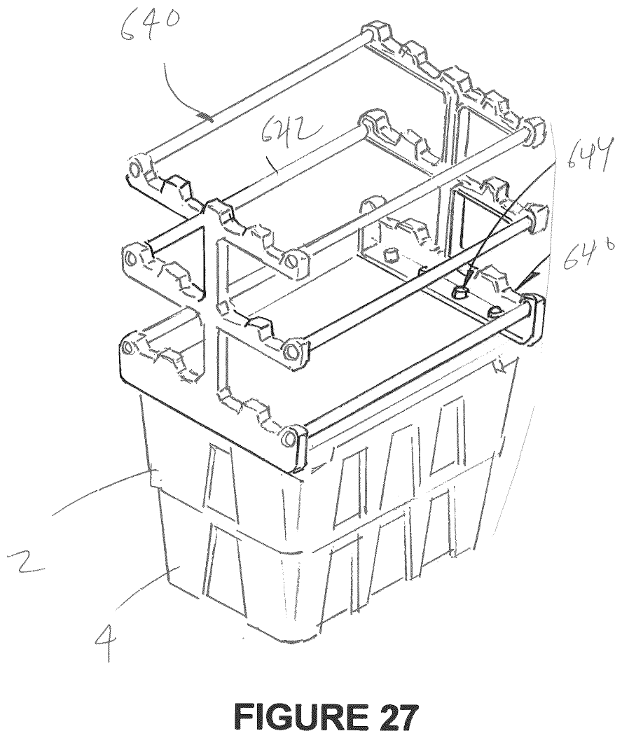

FIG. 27 shows another trellis 640 with connectors 642 and hoses 644 to hold end panels on upper bins 2.

The disclosure has been with reference to a preferred embodiment. Obviously, modifications and alterations will occur to others upon a reading and understanding of the previous detailed description. It is intended that the embodiments be construed as including all such modifications and alterations insofar as they come within the scope of the appended claims and above detailed description.

1. A modular, closed, above-ground garden system, comprising:
a control box containing a pump, timer and a water filter;
a plurality of upper and lower bins, wherein the upper bins provide for passive draining and recycling of water into the lower bin; wherein the lower bins function as water reservoirs;
an internal water manifold within each of the upper bins; and
recirculating water channels to reuse water to reduce overall water usage; wherein said system has a modular configuration to enable multiple systems to be connected together.

2. The system according to claim 1, wherein the upper bin is configured to support various growing methods, including but not limited to soil, NFT, aeroponic, deep water culture, ebb and flow, and drip systems.

3. The system according to claim 1, further comprising protrusions on the ends of the upper bins for attaching trellises or grow racks.

4. The system according to claim 1, wherein the control box can be powered by solar or wind energy.

5. The system of claim 1, further comprising pressure bins connected to the lower bins to the manifolds and irrigation tubing of the upper bins.

6. The system of claim 5, wherein tubing above the upper bins feeds water from the irrigation tubing to associated plants.

7. A modular, closed above-ground garden system, comprising:
a control box having a pump, a water filter, and a timer;
a lower reservoir for holding water; and
manifold positioned relative to the associated plants to be watered.

8. The system of claim 7, wherein water is dripped or dispersed onto said associated plants via the manifold.

9. The system of claim 7, wherein excess water is dispersed via water lines back to the lower reservoir.

10. The system of claim 7, wherein said manifold comprises spray nozzles for spraying water upwardly to roots of associated plants suspended above the manifold.

11. A modular, closed garden system, comprising:
an upper bin to provide water to roots of associated plants;
a timer to control water flow to the upper bin;
a lower bin which provides a water reservoir;
a pump and water filter which pumps water from the lower bin to the upper bin;
wherein the pump pumps water to the upper bin faster than the upper bin drains, wherein the excess water leaves the upper bin and reaches the roots of associated plants.

12. The system of claim 1, wherein the upper bin has a drain hole and a reducer bushing positioned within the drain hole to control drainage from the upper bin.

13. The system of claim 11, wherein clay pellets are placed in the upper bin, wherein the clay pellets are soaked by water and disperse nutrients into the water.

14. The system of claim 11, wherein the pump is an air pump to provide oxygen via diffusers located in the upper bin.

15. The system of claim 14, wherein said diffusers are placed in the upper bin.

16. The system of claim 1, wherein the upper bins comprise channels and flow ports to facilitate external piping to reach manifolds.

17. The system of claim 1, wherein the lower bins comprise plugs to plug a water reservoir.

18. The system of claim 1, wherein the lower bins have a quick disconnect to connect and disconnect a pump.

19. The system of claim 1, further comprising a barrier mounted to an upper end of each of the lower bins to prevent debris and pests from entering the lower bin.

20. The system of claim 1, further comprising a soil separator which is positioned in each of the upper bins to prevent sediment from entering the lower bins.
